(19) United States
(12) Patent Application Publication
(10) Pub. No.: US 2015/0088988 A1
(43) Pub. Date: Mar. 26, 2015

(54) Social Queue on Television

(71) Applicant: Google Inc., Mountain View, CA (US)

(72) Inventors: Yuan Yuan, Redwood City, CA (US); Kareem Aladdin Nassar, Santa Clara, CA (US); Christopher McKillop, Palo Alto, CA (US)

(73) Assignee: Google Inc., Mountain View, CA (US)

(21) Appl. No.: 13/724,646

(22) Filed: Dec. 21, 2012

(51) Int. Cl. H04L 29/08

(52) U.S. Cl. CPC H04L 67/02
USPC 709/204

(57) ABSTRACT

Content such as a television program can be shared by pushing a content identifier to a queue through a social network. A share request from a sender can designate a recipient for the content. An implementation can determine if the sender and the recipient have permission to share the content. If permitted, an identifier associated with the content can be pushed to a viewing queue of the recipient. A user can subscribe to follow a viewing queue, which can provide to the user access to the queue's listing of content, as well as the content itself.

### BACKGROUND

There has been a growing trend to integrate Internet features into television displays, as well as converging computer and television technology. Televisions typically provide limited content to a large audience, whereas the Internet typically provides a vast array of content at the request of an individual. Conventional interactive television technology attempts to bridge the two communication mediums by providing a means for viewers to interact with their televisions through electronic program guides and other means to access content. Interactive television technology has primarily focused on online interactive media, Internet TV, content distribution through set-top boxes, as well as on-demand streaming media.

### BRIEF SUMMARY

The implementation of the disclosed subject matter relates generally to a method and system for users to be able to share their selected content with other friends. More specifically, the implementation relates to pushing, buffering and sharing content on a television. The present disclosure contemplates a new and improved system and method that resolves the above-referenced difficulties and others.

The present disclosure is directed to methods and systems for pushing selected content to a recipient, such as to watch later on a television, and an interface for users to be able to share their selected content with one another, such as via a television or similar interface. In an implementation, a method may include receiving a share request from a sender located at a device that is displaying channel content, which designates a recipient remote from the sender. An identity of the recipient and the channel content being displayed on the sender device may be determined. Based upon the identities of the recipient and the channel content, it may be determined whether the recipient has permission to consume the channel content. The channel content may then be added to a queue associated with the recipient.

An implementation may also determine that the sender has permission to share the content with the recipient. After adding the content to the queue associated with the recipient, the recipient may elect to consume the content immediately, or decline the offer in which case the content may be added to the recipient's queue to view later, or completely rejected by the recipient. The recipient may also request to be removed from the sender's contacts, recipient list, or social group. After viewing the content, the recipient may send comments or ratings about the shared channel content. The comments may be associated with the shared channel content for others to see when they view the content or sent to the sender. Furthermore, the implementation may also identify a subject matter of the channel content and suggest similar channel content to the recipient.

In accordance with another aspect of the disclosed subject matter, an implementation may receive a subscription request from a sender designating a queue associated with a recipient. The sender may be located at a device that is displaying channel content. An identity of the sender and the channel content contained within the queue may be determined. Based upon the identities of the sender and the channel content, it may be determined that the sender has permission to consume the channel content. The queue may then be added to a social group associated with the sender.

A social group may be an arrangement of at least one subscription to a queue associated with a user. An implementation may also receive from the sender an indication to remove users from the social group. In addition, the sender may also filter the channel content added to the social groups based on the content type, content size, or other similar attributes.

Additional features, advantages, and implementations of the disclosed subject matter may be set forth or apparent from consideration of the following detailed description, drawings, and claims. Moreover, it is to be understood that both the foregoing summary and the following detailed description provide examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 is a flow chart illustrating a method for pushing channel content to a queue associated with the recipient according to an implementation of the disclosed subject matter;

FIG. 2 is a flow chart illustrating a method for a third party to subscribe to follow a queue associated with a recipient according to an implementation of the disclosed subject matter.

FIG. 3 shows a computer according to an implementation of the disclosed subject matter.

FIG. 4 shows a network configuration according to an implementation of the disclosed subject matter.

### DETAILED DESCRIPTION

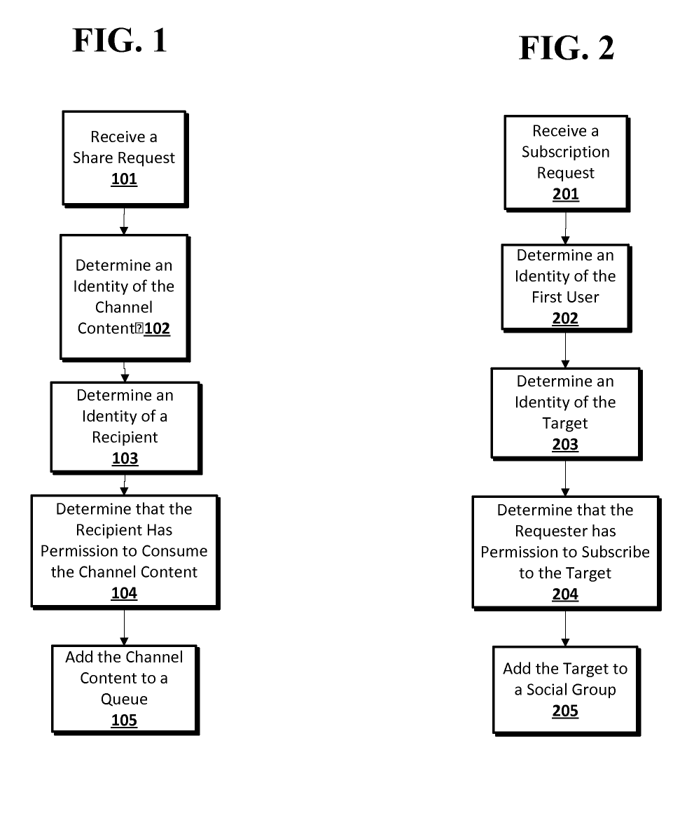

Referring now to the drawings wherein the showings are for purposes of illustrating the preferred implementation of the disclosed subject matter only and not for purposes of limiting same, FIG. 1 provides a view of an example method according to the present disclosure. FIG. 1 shows a method for pushing channel content to a queue associated with the recipient.

The implementation shown in FIG. 1 may receiving a share request 101. The share request may designate a recipient who may be remote from the sender with whom to share channel content being viewed by the sender. Channel content may include a video, a musical piece, a graphic, an animation, a document, or any other related content. In an implementation, a sender may be a user who desires to share experiences based on consuming various media content. The sender may also be a device, such as the device that is displaying the channel content, or a separate device. Similarly, the recipient may be a user who desires to receive shared content from the sender. The recipient may also be a device, such as the device that is displaying the shared channel content, or a separate device. The sender may originate the share request while viewing the channel content via a web browser, a television, a tablet, a smartphone or other related devices. The recipient of any shared content may view the shared content on a television, a tablet, a smartphone, or other related devices. In an implementation, the sender may indicate within an interface provided on the television that he'd like to share a movie that he is currently viewing and may designate a friend as a recipient.

The identity of the content to be shared 102 can be designated by the sender himself (e.g., by selecting the content to be shared from a menu) or it may be determined by the implementation. For example, the implementation can monitor which content the sender is viewing at the time the sender initiates the share request and designate that content to be shared with the recipient. Likewise, the implementation can monitor the channel through which the content is being viewed by the sender and the time of day at which the sender designates the recipient. It can lookup the content being viewed at that time and on that channel by the sender and thereby determine the identity of the content to be shared.

An implementation can determine the identity of the recipient 103. The recipient can be designated by the sender in the share request. The recipient can be designated individually, as a member of a group, or as a member of a set of recipients having attributes that meet a given criteria. For example, the sender can designate recipients that are members of a sender social network and that subscribe to a given premium channel. Likewise, a sender can designate recipients that are members of the sender's “Friends” social group, the sender's “Relatives” social group, and so on.

The identity of the recipient can be used by an implementation to determine if the recipient has permission to consume 104 (e.g. view, listen to, etc.) the channel content designated to be shared with the recipient by the sender. This permission can also be based upon the identity of the channel content, the type of channel content, the identity of the channel itself, the age of the recipient, the geographical location of the recipient, the time of day or date, other members of the recipient's social networks (e.g., social groups), subscription information such as the terms of a package subscription, parental control classification, ratings such as content maturity ratings, viewer ratings, critics ratings, etc. For example, if the sender requests to share the content aired on his premium subscription channel, the recipient may not be able to view the content without subscribing to the channel. Here, the implementation can help to ensure that premium subscription material, or otherwise legally protected material is not shared freely among users who do not have appropriate rights to access the content.

In an implementation, ancillary information can be associated with a share request, a sender, a recipient and/or the content being shared, which are examples of share request properties. Such ancillary information can be shown to the recipient as a result of the share request. For example, is a sender has shared premium channel content and the recipient does not have a subscription to the premium channel, an implementation can provide an advertisement or interface to the recipient inviting the recipient to subscribe. Likewise, an advertisement can be selected based upon share request properties. The advertisement can be delivered to the recipient, to the sender, or to both.

An implementation may determine whether the sender has permission to share the content with the recipient. This permission can be based upon the identity of the sender, the identity of the channel content, the type of channel content, the identity of the channel itself, the age of the sender, the geographical location of the sender, the time of day or date, other members of the recipient's social networks (social groups), subscription information such as the terms of a package subscription, parental control classification, ratings such as content maturity ratings, viewer ratings, critics ratings, etc. For example, if the sender requests to share the content with the recipient, the recipient may safeguard her queue against spam or advertisements by disallowing specific senders from sharing content with her. Here, the implementation seeks to ensure that spam users or advertisers are not flooding unsuspecting recipients with unwanted channel content. In an implementation, content that is associated with a share request is shared with the recipient if the sender is authorized to share the content and the recipient is authorized to consume the content.

An implementation may also add the channel content 105 to a queue associated with the recipient. A queue may be an arrangement of items that are in an order. Items may be added and taken from a queue in accordance with various schemes. For example, a queue may operate on a first-in, first-out basis. In a first-in-first-out scheme, the first element added to the queue will be the first one to be removed. Examples of first-in, first-out queues include checkout lines, escalators, coin dispensers, and vending machines. In each of the cases, the object at the front of the line was the first one to enter, while the object at the end of the line is the last to have entered. Every time a customer finishes paying for their items (or a person steps off the escalator, or a coin is removed from a tube of the coin dispenser, etc.) that object leaves the queue from the front. A queue in accordance with implementations of the disclosed subject matter may also operate using a last-in, first-out scheme in which the last element added to the queue is the first one to be removed. Likewise, the queue may be a last-in, last-out queue or any other type of queue. In addition, the order and/or presence of items in a queue can be changed. For example, the order of the items may be randomly shuffled, or reorganized in accordance with any rule or filter. For example, the items in the queue may be filtered by content type, maturity ratings, running length, source or any other content attribute. A filter can be a rule that determines which items in the queue are visible, invisible, available, not available or present or not present in the queue. The items in the queue may be reordered by running length, file size, content type, source, or any other content attribute or other criteria.

In an implementation, a queue may be an aggregation of channel content that has been added by a user, such as a sender, more than one sender, an implementation, a recipient or a combination. Using a queue can simplify the management of channel content that can be pushed and buffered from one or more users. Furthermore, a queue may provide a pre-arranged scheme to help the recipient to navigate the queue items. In some implementations, items in the queue also may be accessible by the user in any order, such as where the queue is presented as a list from which the user can select any item to view or otherwise access.

After sending the content to the recipient, the recipient may elect to consume the content immediately or defer consumption, in which case the content may be added to the recipient's queue to view later. The recipient may also reject the content. The recipient may also request to be removed from the sender's contacts, recipient list, or social group. After viewing the content, the recipient may send comments or ratings about the shared channel content. The comments may be associated with the shared channel content for others to see when they view the content or sent to the sender. Furthermore, the implementation may also identify a subject matter of the channel content and suggest similar channel content to the recipient.

While various implementations of the present disclosure have been described above, it should be understood that they have been presented by way of example and not limitation. It will be apparent to one skilled in the pertinent art that various changes in form and detail can be made therein without departing from the spirit and scope of the present disclosure.

FIG. 2 shows an implementation where a user subscribes to “follow” a queue and/or a recipient. A recipient can be associated with more than one queue, so the user can specify which queue of the recipient's to follow. Likewise, the user can subscribe to follow a recipient, i.e., to follow the one or more queues associated with the recipient. A subscription to follow a recipient can allow the sender to view the recipient's queued contents and watch them at his convenience.

A subscription request can be received from a requesting user, 201. The subscription request can be used by the implementation to determine the identity of the requester 202 and the identity of a target (e.g., another user or queue) sought to be followed 204 by the requesting user. An implementation can determine if the requesting user has permission to follow the designated other user or queue 204. If the requesting user has permission, an implementation can permit the requesting user to follow the target, for example by adding the target to a social group of the requesting user 205. This can permit the requesting user to access one or more content items on the followed queue or to simply view a list of content items in the followed queue.

An implementation can also determine if a requesting user following a queue has permission to access content items in the followed queue. In other words, in some implementations, a requesting user who is permitted to follow a queue may not have permission to consume some or all of the content items in the queue. Permission can be determined as described above for sharing permission. In some cases, the requesting user may only be permitted to view the items in a queue. In other cases, the requesting user may be permitted to consume only some, but not all, of the content items in the queue. In yet other cases, the requesting user can access all of the items in the followed queue.

In an implementation, if the requesting user is determined not to have permission to consume a content item in a followed queue, an implementation may send to the requesting user an invitation to subscribe to a premium channel, pay for the requested content, etc. If the requesting user accepts the invitation and subscribes or pays, then the implementation can send the requested content to the requesting user. In an implementation, the user can obtain permission to consume the requested content by performing an action described in a notice that can be sent by the implementation, such as joining a social group, endorsing a product, sharing an e-mail address, changing a privacy setting of the requesting user, etc. The implementation may also select an advertisement to send to the requesting user in response to the request for content. The advertisement may be selected based on the identity of the requesting user, the identity of the target, one or more attributes of the requested content as described above for determining sharing permission, etc. The sender may also unsubscribe (stop following) a target by submitting a request to do so to the implementation.

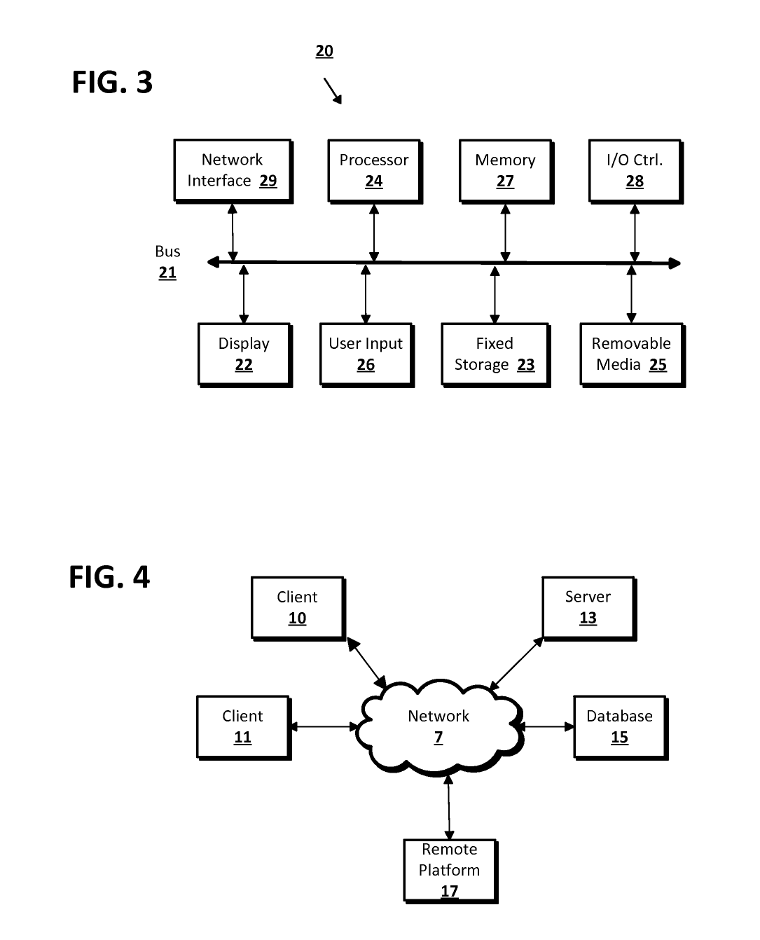

Embodiments of the presently disclosed subject matter may be implemented in and used with a variety of component and network architectures. FIG. 3 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a share request from a sender viewing channel content, the share request designating a recipient;
determining an identity of the channel content being displayed on the device;
determining an identity of the recipient;
determining that the recipient has permission to consume the channel content based upon the identity of the recipient and the identity of the channel content; and
adding the channel content to a queue associated with the recipient.

2. A method as recited in claim 1, further comprising determining that the sender has permission to share the content with the recipient.

3. A method as recited in claim 1, wherein the sender is at least one entity selected from the group consisting of: a sender device and a sender user.

4. A method as recited in claim 1, wherein the recipient is at least one entity selected from the group consisting of: a recipient device and a recipient user.

5. A method as recited in claim 1, wherein the device is at least one device selected from the group consisting of: a television, a tablet, and a smartphone.

6. A method as recited in claim 1, wherein the channel content being rendered on the device is at least one type of content selected from the group consisting of: a video, a musical piece, a graphic, an animation and a document.

7. A method as recited in claim 1, wherein determining that the recipient has permission to consume the channel content is further based upon at least one attribute of the channel content selected from the group consisting of: a channel, a type, a package, a subscription period, a parental control classification and a rating.

8. A method as recited in claim 1, wherein the queue comprises a channel associated with at least one entity selected from the group consisting of: the sender, the recipient, the type of content, a parental control, a classification and a rating.

9. A method as recited in claim 1, further comprising receiving a request from the recipient to consume the content and streaming the content to the recipient.

10. A method as recited in claim 1, further comprising receiving a request from the recipient to decline the content.

11. A method as recited in claim 1, further comprising receiving a comment about the channel content.

12. A method as recited in claim 1, further comprising receiving a rating of the channel content.

13. A method as recited in claim 1, wherein the content is associated with a subject matter and further comprising identifying a subject matter of the channel content, and suggesting similar subject matter to the recipient.

14. A method comprising:
receiving a subscription request from a first user, the subscription request designating a target associated with a second user, the target associated with a queue containing a list of content items;
determining an identity of the first user;
determining an identity of the target associated with the second user;
determining that the first user has permission to subscribe to the designated target based upon the identity of the first user and the identity of the target ; and
adding the target to a social group associated with the first user.

15. A method as recited in claim 14, further comprising determining that the first user has permission to subscribe to the designated target based upon the identity of at least one content item attribute.

16. A method as recited in claim 15, wherein the content item attribute is at least one entity selected from the group consisting of: content size, content type, running length, file size, source, a parental control classification and a rating.

17. A method as recited in claim 14, wherein the queue comprises a channel associated with at least one entity selected from the group consisting of: the first user, the second user, the type of content, a parental control classification and a rating.

18. A method as recited in claim 14, further comprising determining that the first user has permission to consume channel content within the queue based upon the identity of the first user and an identity of the channel content.

19. A method as recited in claim 14, further comprising determining that the first user does not have permission to consume channel content within the queue based upon the identity of the first user and an identity of the channel content.

20. A method as recited in claim 19, further comprising sending to the first user a request to subscribe to the channel content.

21. A method as recited in claim 20, wherein the request to subscribe to the channel content is at least one type of request selected from the group consisting of: request to subscribe to a premium channel associated with the channel content, request to pay for the channel content, request to join a social group, request to endorse a product, request to share an email address, request to change a privacy setting.

22. A method as recited in claim 19, wherein determining whether the first user has permission to consume the channel content comprises: determining that the first user has permission to consume the channel content having at least one attribute selected from the group consisting of: a channel, a type, a package, a subscription period, a parental control classification and a rating.
